(19) United States
(12) Patent Application Publication
(10) Pub. No.: US 2009/0295916 A1
(43) Pub. Date: Dec. 3, 2009

(54) CMOS array sensor film scanner capable of executing the preview, scanning and storage functions without connecting with a computer

(76) Inventor: Li Chi Hsu, China Hong Kong City (HK)

Correspondence Address: SILICON VALLEY PATENT AGENCY, 7394 WILDFLOWER WAY, CUPERTINO, CA, 95014, US

(21) Appl. No.: 12/219,875

(22) Filed: Jul. 30, 2008

(30) Foreign Application Priority Data
May 30, 2008 (TW) 097209446

(51) Int. Cl. H04N 5/253

(52) U.S. Cl. 348/96; 348/E05.049

(57) ABSTRACT

A film scanner is disclosed. The film scanner can provide a preview, scanning and storage functions without connecting to a computer. It is characterized in that a PCBA module includes a main board, a function key board and a screen display panel, an image sensor with a lens and an image processing and storage module. A backlight mechanism is set near the bottom of the film scanner. In addition, a memory card inserting may be provided. The film scanner operates independently and allows a user to preview a digitalized image captured from a film.

### BACKGROUND OF THE INVENTION

We all know that the traditional camera utilizes the light sensitive film (positive or negative film) as a photographic film. But this plastic based film is hard to be stored, the images will be lost or damaged after a period of time thus the stored images are unable to be developed and printed again. Furthermore, the fixed images stored in the films are unable to be modified unless professional and expensive machines and tools are used.

With the advancement in the computers and digital technologies, a scanner designed for scanning normal documents or drawings, sometimes including a backlight mechanism to scan negative films so as to transfer images from the files into digital images is commonly seen in the market. But such a scanning device is often large in size, heavy in weight, and of high cost. Although there are other designs to scan negative film independently, most of which are lack of utility in use on volume and cost and are not popular in the market.

The applicant of the present invention believes an independent scanning device that can transfer the traditional photographic films into digital images is a design of choice. However, the applicant also finds that it is not ideal because such a device would only be used with a computer. Without a computer, the device would not be operated independently to enable many of its functions. At the same time, it is also found that the driver used in the device can only work with the negative films and cannot work with the positive films. Moreover, the necessary scanning time and the cost are unacceptable to most users.

Therefore, after the research and improvement, the inventor of the present application completes a standalone film scanner that provides a preview, scanning and storage functions without connecting to a computer.

### SUMMARY OF THE INVENTION

The present invention is related to a standalone film scanner. In one embodiment, a CMOS array sensor is used in the film scanner that provides a preview, scanning and storage functions without connecting to a computer. The file scanner is a standalone device that can transfer traditional photographic film images into digital data. The images on the films can be transformed into digital data quickly by easy operations with its internal backlight mechanism and optical camera lens. The scanner can perform digitizing and image processing for previewing, editing then storing in a memory card through a color display outside the scanner. It thus provides convenience of carrying around and using anywhere.

The structures and characteristics of embodiments of the present invention will be described hereafter by referring to drawings.

### BRIEF DESCRIPTION OF THE DRAWINGS

FIG. 1 is a three-dimensional drawing of an outside appearance of a scanning device according to one embodiment of the present invention;

FIG. 2 to 4 show respectfully the structural setting and implementation of the embodiment of FIG. 1;

FIGS. 5 and 6 are structural drawing of the film trays; and

FIG. 7 is a perspective drawing of an X-ray clamp according to one embodiment of the present invention.

### DETAILED DESCRIPTION OF THE PREFERRED EMBODIMENT

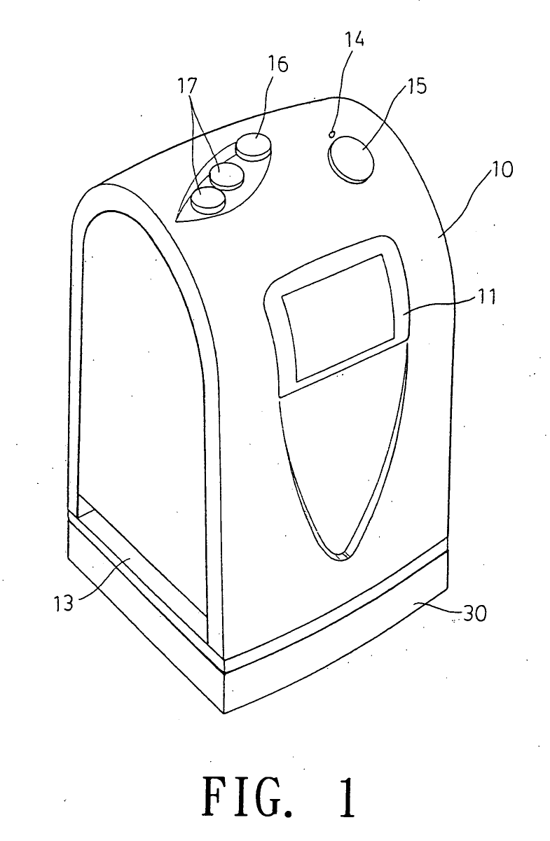

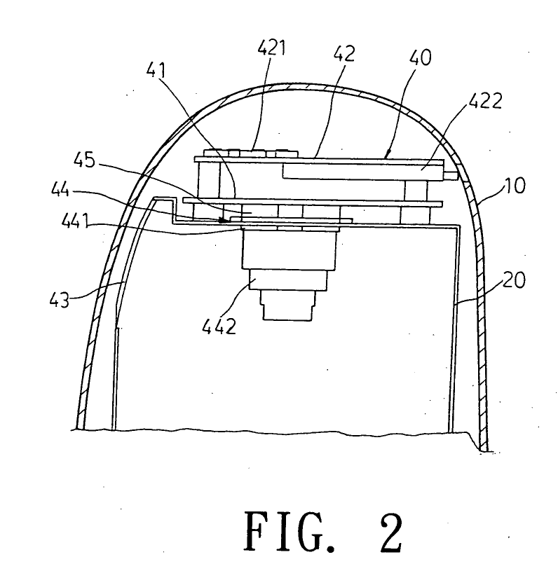

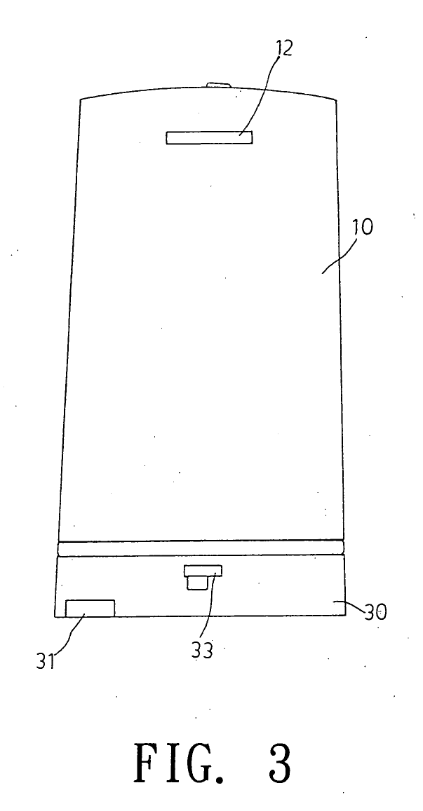

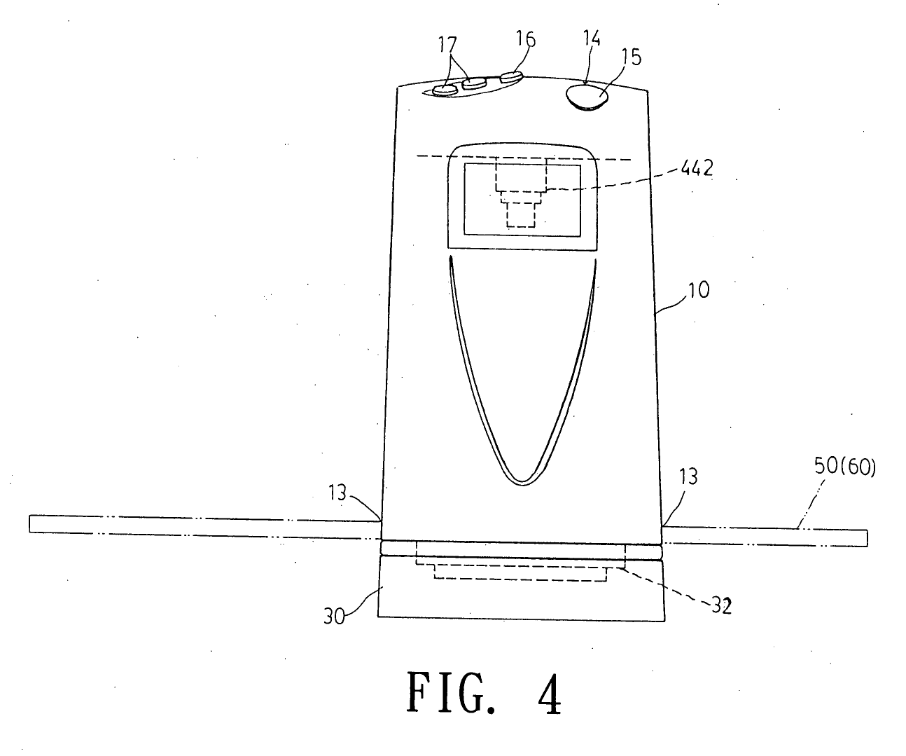

Please refer to FIGS. 1 to 4. According to one embodiment, the present invention is to provide a CMOS array sensor film scanner that provides a preview, scanning and storage functions without connecting to a computer. As shown in FIG. 1, it has a main body 10 internally set with a body frame 20, and with its bottom connected with a base 30 internally set with a backlight mechanism 32.

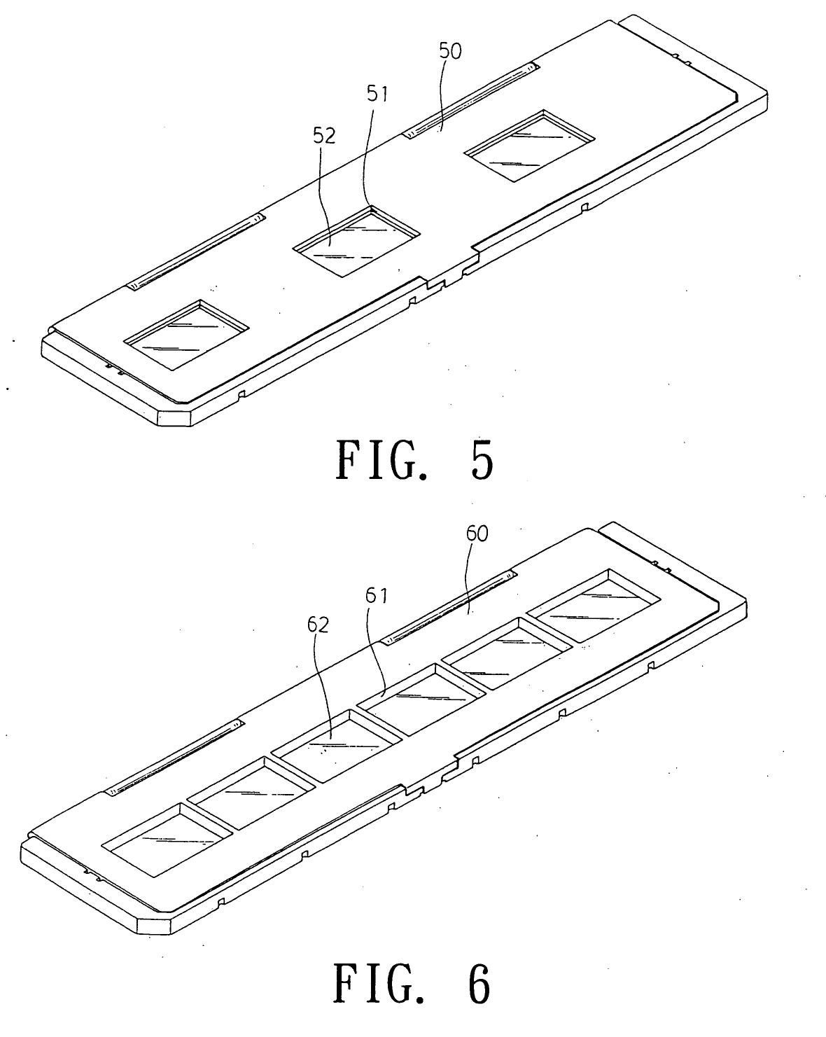

One of the main features is that a PCBA (printed circuit board assembly) module 40 includes an main board 41, a function key board 42 and a screen display panel 43 coupled together and is mounted on top of the body frame 20 in the main body 10. An image sensor module 44 includes an image sensor 441 (which can be a Complementary Metal Oxide Semiconductor image sensor in one embodiment), an optical camera lens 442 and an image processing and storage module 45 (which may further includes synchronous dynamic memory, flash memory and digital signal processing chips). An array of functional switches 421 and memory card tray 442 are set on the function key board 42. The screen display panel 43 may be a colored LCD (liquid crystal display) 11. An internal-set power supply device 31 capable of providing AC, DC functions or a USB power connector may be set on the base 30. An LED light sourced backlight mechanism 32 and an USB socket 33 are set relative to the optical camera lens 442. The colored LCD (liquid crystal display) 11 and a memory card inserting socket 12 are set on the outside of the main body 10. Furthermore, a pair of elongated slots 13 is formed on left and right sides of the main body 10. Also, a power indicating lamp 14, a shooting key 15, a power key 16 and an operation key 17 are set on top of the main body 10, and can be linked with the function switch 421 on the function key board 42. Furthermore, there are separately a set of film trays 50, 60 used for clamp-setting the positive film 52 and negative film 62, shown in FIGS. 5 and 6 respectively.

In operation, firstly, the power key 16 is pressed and the power indicating lamp 14 is on. The film tray 50 (or 60) clamp-set with films is inserted in from one the slots 13. Once the film of opening window 51 (or 61) is on top of the backlight mechanism 32, a user can press the shooting key 15 provided that the optical camera lens 442 is aimed at the file. The backlight mechanism 32 is activated to emit the light to expose and show the image of the film. The optical camera lens 442 is utilized to focus the film images onto the image sensor 441 through which the images are transformed into electronic images that become digital data via an AD process. The digitized image is processed through the image processing and storage module 45. Through the screen display panel 43, the preview of the image can be provided directly on the colored LCD display 11 of the main body, or the image can be stored in the memory card after proceeding some editing through the function key 17. The image stored in the memory card is also accessed for repeated display or editing through the image processing and storage module 45. Secondly, if needed, the scanner can cooperate with a host computer through an external-connected USB cable that can be inserted in the USB socket 33 and the same on the host computer.

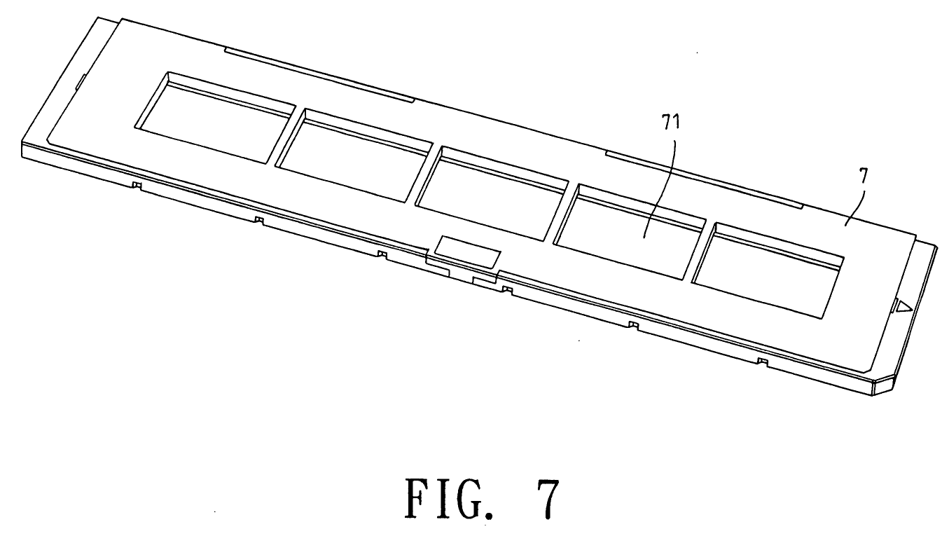

In the present invention, a timer can be connected with the backlight mechanism for automatic turn-off after no use for a period of time, which will save the lifetime of the device. The device can be applied for positive films, negative films, black-white films, and X-ray films 71 received in a related clamp 7, as shown in FIG. 7. It will be understood that the image created by the present invention can be in color. Another improvement in the present invention is that the image optical camera lens module includes a compensative function in controlling a degree of lighting, which assists to obtain the most fidelity in displayed color and obvious effect.

1. (canceled)

2. (canceled)

3. (Canceled)

4. (Canceled)

5. (Canceled)

6. (Canceled)

7. (Canceled)

8. (Canceled)

9. (Canceled)

10. A film scanner comprising:
a housing;
an array of function keys mounted on top of the housing to allow a user to activate a particular function;
an image sensor mounted inside of the housing;
a backlighting mechanism mounted near bottom of the housing; and
a first slot to receive a film tray holding at least a film, a second slot to exit the film tray, wherein as the film tray is stopped and the film is illuminated by the backlighting mechanism and focused onto the image sensor by a lens, an image of the film is created when one of the keys is activated.

11. The film scanner as recited in claim 10, further comprising:
a display panel mounted on top of the housing; and
a circuitry board including an AD function and an image processing function, wherein the AD function is used to digitalize the image of the film to create a digitized image that is further processed by the image processing function to display the digitized image on the display panel for preview.

12. The film scanner as recited in claim 11, further comprising:
a memory mechanism to receive a memory card, wherein the digitized image is stored into the memory card.

13. The film scanner as recited in claim 12, wherein the housing includes a power supply to energize the film scanner.

14. The film scanner as recited in claim 12, wherein the film scanner operates independently without being connected to a host computer.

15. The film scanner as recited in claim 12, wherein the film scanner operates by drawing power from a host computer.

16. The film scanner as recited in claim 10, wherein the film is one of a negative film, a positive film, a black-white film, and an X-ray film.

17. The film scanner as recited in claim 16, wherein the film tray includes a plurality of windows, each being used to expose one film placed therein, the tray is a type of clamp setting.

18. The film scanner as recited in claim 10, wherein the backlighting mechanism is automatically turned off after the film scanner is not used for a period of time.

19. The film scanner as recited in claim 10, further including a lens mechanism with a compensative function in controlling a degree of lighting to assist the film scanner to obtain the most fidelity in displayed color of the film.

20. The film scanner as recited in claim 10, wherein the film scanner is a stand-alone device operating independently.
